(19) United States
(12) Patent Application Publication
(10) Pub. No.: US 2016/0044302 A1
(43) Pub. Date: Feb. 11, 2016

(54) AUTOSTEREOSCOPIC 3D DISPLAY DEVICE

(71) Applicant: Shenzhen China Star Optoelectronics Technology Co., Guangdong (CN)

(72) Inventors: Bin Fang, Guangdong (CN); Deyong Fan, Guangdong (CN)

(73) Assignee: Shenzhen China Star Optoelectronics Technology Co., Guangdong (CN)

(21) Appl. No.: 14/403,260

(22) PCT Filed: Aug. 13, 2014
(86) PCT No.: PCT/CN2014/084234

§ 371 Date: Nov. 24, 2014

(30) Foreign Application Priority Data
Aug. 8, 2014 (CN) 201410390983.4

(51) Int. Cl. H04N 13/04; G02F 1/133; G02F 1/1334

(52) U.S. Cl. CPC H04N 13/0409; H04N 13/0497; H04N 13/0445; H04N 13/0422; G02F 1/1334; G02F 1/13306

(57) ABSTRACT

An autostereoscopic 3D display device is disclosed. The autostereoscopic 3D display device includes: a display panel; an autostereoscopic 3D panel; an image comparing module; and a scattering module. The autostereoscopic 3D display device scatters a part of the emitting lights of one display image by disposing the image comparing module and the scattering module, thereby reducing the moire pattern phenomenon on the basis of without increasing the crosstalk of the display image.

### BACKGROUND OF THE INVENTION

1. Field of the Invention

The present invention generally relates to a display technical field, and more particularly to an autostereoscopic 3D display device.

2. Description of Prior Art

With the development of the display technology, more and more users utilize various display devices to view social entertainment activities. The users can view 3D images without utilizing external devices (e.g. 3D glasses) especially when autostereoscopic 3D display devices are utilized.

The conventional autostereoscopic 3D display devices make users experience 3D feeling by the binocular disparity principle. That is, light paths of incident lights are adjusted such that a user's right eye receives right eye images and the user's left eye receives left images. Furthermore, the left eye images and the right eye images do not interfere with each other.

Conventional autostereoscopic 3D display devices mainly comprise barrier type autostereoscopic 3D display devices and lens type autostereoscopic 3D display devices.

FIG. 1 shows a structure of a barrier type autostereoscopic 3D display device, which comprises a display panel 11 and a shutter plate 12. In the barrier type autostereoscopic 3D display device, the shutter plate 12 blocks left eye images L (or right eye images R), such that the user's left eye (or right eye) can receive the left eye images L (or right eye images R) and cannot receive the right eye images R (or left eye images L). Accordingly, the user can perceive effect of one 3D image.

FIG. 2 shows a structure of a lens type autostereoscopic 3D display device, which comprises a display panel 21 and a lens 22. In the lens type autostereoscopic 3D display device, the lens 22 refracts lights in different directions, such that the user's left eye (or right eye) can receive the left eye images L (or right eye images R) and cannot receive the right eye images R (or left eye images L). Accordingly, the user can perceive effect of one 3D image.

However, one conventional autostereoscopic 3D display device comprises three colors of subpixels including red subpixels, green subpixels, and blue subpixels. The red subpixels, the green subpixels, and the blue subpixels are regularly arranged in different positions of space. As a result, in the autostereoscopic 3D display device in FIG. 1 or FIG. 2, since the shutter plate 12 adjusts the directions of the incident lights or the lens 22 amplifies the lights, color strips of the red subpixels, the green subpixels, and the blue subpixels or black and white strips are alternately displayed when the user view the autostereoscopic 3D display device in FIG. 1 or FIG. 2. The color strips and the black and white strips are moire patterns. The generated moire patterns affect display quality of one 3D image.

In order to reduce the generated moire patterns of an autostereoscopic 3D display device, a designer of the autostereoscopic 3D display device disposes a light diffuser between the shutter plate 12 (or lens 22) and the display panel 11 (or display panel 21) or at an outer side of the shutter plate 12 (or lens 22). By doing so, the emitting lights from the display panel 11 (or display panel 21) are scattered after passing through the light diffuser, and the generated moire patterns can be reduced.

Although the moire patterns can be reduced by disposing the light diffuser, the left eye images and the right eye images are scattered by the light diffuser in the meantime. Accordingly, 3D crosstalk of one display image is increased, and the display quality of the autostereoscopic 3D display device is affected.

Consequently, there is a need to provide an autostereoscopic 3D display device for solving the problems in the prior art.

### SUMMARY OF THE INVENTION

An objective of the present invention is to provide an autostereoscopic 3D display device capable of solving the technical problems that the moire pattern phenomenon is serious or the crosstalk of the display image is large in a conventional autostereoscopic 3D display device in the prior art.

To solve the above-mentioned problems, a technical scheme of the present invention is described as follows. An autostereoscopic 3D display device of the present invention comprises: a display panel for displaying a plurality of left eye images and a plurality of right eye images; an autostereoscopic 3D panel for adjusting emitting angles of emitting lights of the left eye images and emitting angles of emitting lights of the right eye images; an image comparing module for comparing a gray level of each of the left eye images with a gray level of a corresponding one of the right eye images and generating comparison results; and a scattering module for scattering at least a part of the emitting lights of the left eye images and the emitting lights of the right eye images according to the comparison results. The autostereoscopic 3D panel is a barrier type autostereoscopic 3D panel or a lens type autostereoscopic 3D panel. The scattering module is disposed between the display panel and the autostereoscopic 3D panel or disposed at a light emitting surface side of the autostereoscopic 3D panel.

In the autostereoscopic 3D display device of the present invention, each of the left eye images and the right eye images comprises a plurality of image comparing areas. When a difference between a gray level of one of the image comparing areas in one of the left eye images and a gray level of a corresponding one of the image comparing areas in a corresponding one of the right eye images is smaller than a preset value, the scattering module scatters the emitting lights of the one of the image comparing areas in the one of the left eye images and the emitting lights of the corresponding one of the image comparing areas in the corresponding one of the right eye images. When the difference between the gray level of the one of the image comparing areas in the one of the left eye images and the gray level of the corresponding one of the image comparing areas in the corresponding one of the right eye images is larger than the preset value, the scattering module does not scatter the emitting lights of the one of the image comparing areas in the one of the left eye images and the emitting lights of the corresponding one of the image comparing areas in the corresponding one of the right eye images.

In the autostereoscopic 3D display device of the present invention, the scattering module is a polymer dispersed liquid crystal film. The polymer dispersed liquid crystal film comprises: a plurality of scattering processing units for scattering emitting lights at different positions of the display panel; and a plurality of voltage applying units for applying controlling voltages for the scattering processing units. The scattering processing units and the voltage applying units are in one-to-one correspondence.

In the autostereoscopic 3D display device of the present invention, when one of the voltage applying units applies one controlling voltage to a corresponding one of the scattering processing units, the emitting lights of the display panel pass the corresponding one of the scattering processing units. When the one of the voltage applying units applies no controlling voltage to the corresponding one of the scattering processing units, the corresponding one of the scattering processing units scatters the emitting lights of the display panel.

In the autostereoscopic 3D display device of the present invention, the image comparing areas and the scattering processing units are in one-to-one correspondence.

In the autostereoscopic 3D display device of the present invention, each of the left eye images and the right eye images comprises a plurality of image comparing areas. The scattering module is a polymer dispersed liquid crystal film. The polymer dispersed liquid crystal film comprises: a plurality of scattering processing units for scattering emitting lights at different positions of the display panel; and a plurality of voltage applying units for applying controlling voltages for the scattering processing units. The scattering processing units and the voltage applying units are in one-to-one correspondence. The scattering module determines the controlling voltages applied to the scattering processing units according to the comparison results.

In the autostereoscopic 3D display device of the present invention, the display panel is a two-view display panel or a multi-view display panel.

In the autostereoscopic 3D display device of the present invention, the display panel is a multi-view display panel. The multi-view display panel is utilized for displaying at least two left eye images and at least two right eye images at the same time. The image comparing module is utilized for comparing one gray level of each of the left eye images with a gray level of a corresponding one of the right eye images and generating comparison results.

An autostereoscopic 3D display device of the present invention comprises: a display panel for displaying a plurality of left eye images and a plurality of right eye images; an autostereoscopic 3D panel for adjusting emitting angles of emitting lights of the left eye images and emitting angles of emitting lights of the right eye images; an image comparing module for comparing a gray level of each of the left eye images with a gray level of a corresponding one of the right eye images and generating comparison results; and a scattering module for scattering at least a part of the emitting lights of the left eye images and the emitting lights of the right eye images according to the comparison results.

In the autostereoscopic 3D display device of the present invention, each of the left eye images and the right eye images comprises a plurality of image comparing areas. When a difference between a gray level of one of the image comparing areas in one of the left eye images and a gray level of a corresponding one of the image comparing areas in a corresponding one of the right eye images is smaller than a preset value, the scattering module scatters the emitting lights of the one of the image comparing areas in the one of the left eye images and the emitting lights of the corresponding one of the image comparing areas in the corresponding one of the right eye images. When the difference between the gray level of the one of the image comparing areas in the one of the left eye images and the gray level of the corresponding one of the image comparing areas in the corresponding one of the right eye images is larger than the preset value, the scattering module does not scatter the emitting lights of the one of the image comparing areas in the one of the left eye images and the emitting lights of the corresponding one of the image comparing areas in the corresponding one of the right eye images.

In the autostereoscopic 3D display device of the present invention, the scattering module is a polymer dispersed liquid crystal film. The polymer dispersed liquid crystal film comprises: a plurality of scattering processing units for scattering emitting lights at different positions of the display panel; and a plurality of voltage applying units for applying controlling voltages for the scattering processing units. The scattering processing units and the voltage applying units are in one-to-one correspondence.

In the autostereoscopic 3D display device of the present invention, when one of the voltage applying units applies one controlling voltage to a corresponding one of the scattering processing units, the emitting lights of the display panel pass the corresponding one of the scattering processing units. When the one of the voltage applying units applies no controlling voltage to the corresponding one of the scattering processing units, the corresponding one of the scattering processing units scatters the emitting lights of the display panel.

In the autostereoscopic 3D display device of the present invention, the image comparing areas and the scattering processing units are in one-to-one correspondence.

In the autostereoscopic 3D display device of the present invention, the autostereoscopic 3D panel is a barrier type autostereoscopic 3D panel.

In the autostereoscopic 3D display device of the present invention, the autostereoscopic 3D panel is a lens type autostereoscopic 3D panel.

In the autostereoscopic 3D display device of the present invention, the scattering module is disposed between the display panel and the autostereoscopic 3D panel.

In the autostereoscopic 3D display device of the present invention, the autostereoscopic 3D panel is disposed at a light emitting surface side of the autostereoscopic 3D panel.

In the autostereoscopic 3D display device of the present invention, each of the left eye images and the right eye images comprises a plurality of image comparing areas. The scattering module is a polymer dispersed liquid crystal film. The polymer dispersed liquid crystal film comprises: a plurality of scattering processing units for scattering emitting lights at different positions of the display panel; and a plurality of voltage applying units for applying controlling voltages for the scattering processing units. The scattering processing units and the voltage applying units are in one-to-one correspondence. The scattering module determines the controlling voltages applied to the scattering processing units according to the comparison results.

In the autostereoscopic 3D display device of the present invention, the display panel is a two-view display panel or a multi-view display panel.

In the autostereoscopic 3D display device of the present invention, the display panel is the multi-view display panel, the multi-view display panel is utilized for displaying at least two left eye images and at least two right eye images at the same time, and the image comparing module is utilized for comparing one gray level of each of the left eye images with a gray level of a corresponding one of the right eye images and generating comparison results.

Compared with the conventional autostereoscopic 3D display device, the autostereoscopic 3D display device of the present invention scatters a part of the emitting lights of one display image by disposing the image comparing module and the scattering module, thereby reducing the moire pattern phenomenon on the basis of without increasing the crosstalk of the display image. Accordingly, the technical problems that the moire pattern phenomenon is serious or the crosstalk of the display image is large in a conventional autostereoscopic 3D display device in the prior art are solved.

For a better understanding of the aforementioned content of the present invention, preferable embodiments are illustrated in accordance with the attached figures for further explanation:

### BRIEF DESCRIPTION OF THE DRAWINGS

FIG. 1 shows a structure of a barrier type autostereoscopic 3D display device;

FIG. 2 shows a structure of a lens type autostereoscopic 3D display device;

FIG. 3A shows a structural diagram of an autostereoscopic 3D display device in accordance with a first preferred embodiment of the present invention;

FIG. 3B shows a structural diagram of a scattering module in accordance with the first preferred embodiment of the present invention;

FIG. 3C shows a left eye image and a right eye image displayed by the autostereoscopic 3D display device in accordance with the first preferred embodiment of the present invention;

FIG. 4 shows a structural diagram of an autostereoscopic 3D display device in accordance with a second preferred embodiment of the present invention;

FIG. 5 shows a structural diagram of an autostereoscopic 3D display device in accordance with a third preferred embodiment of the present invention;

FIG. 6 shows a structural diagram of an autostereoscopic 3D display device in accordance with a fourth preferred embodiment of the present invention; and

FIG. 7 shows a structural diagram of an autostereoscopic 3D display device in accordance with a fifth preferred embodiment of the present invention.

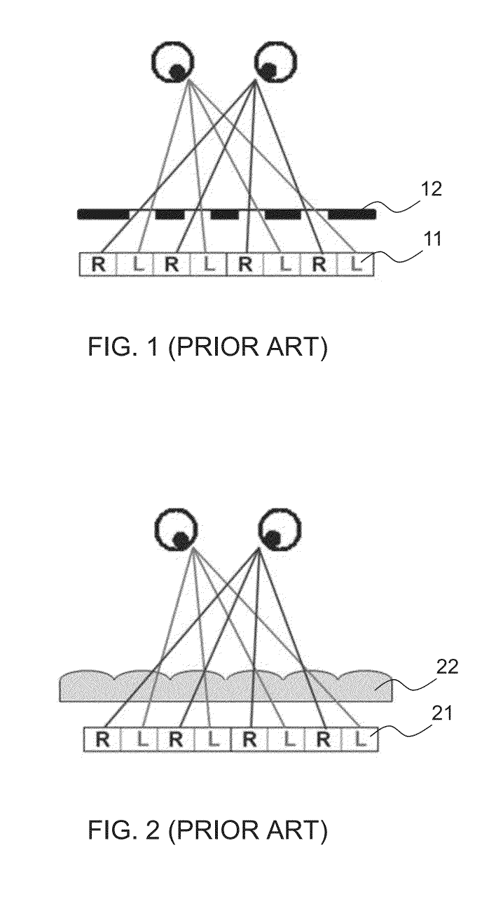

### DETAILED DESCRIPTION OF THE INVENTION

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

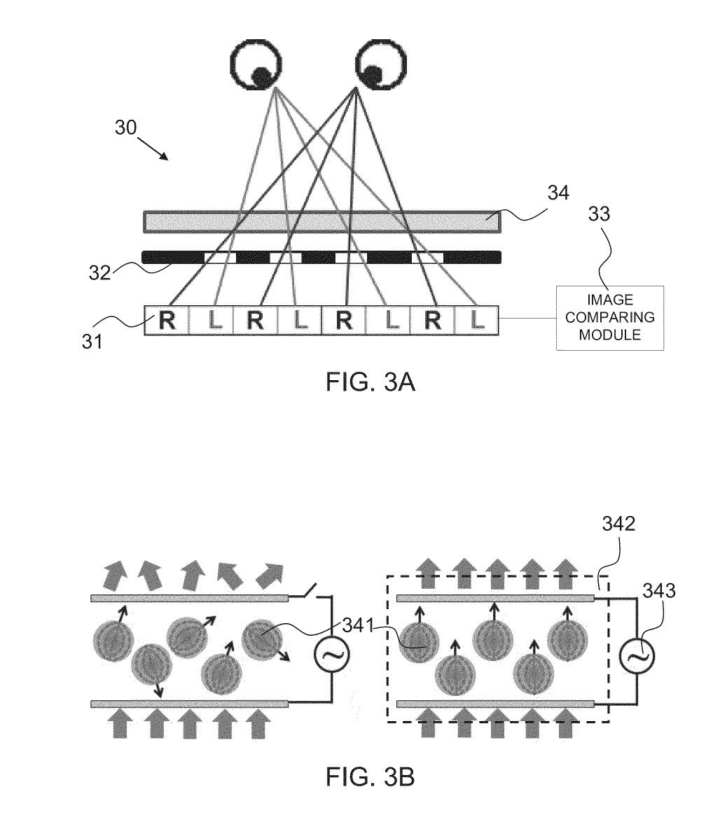

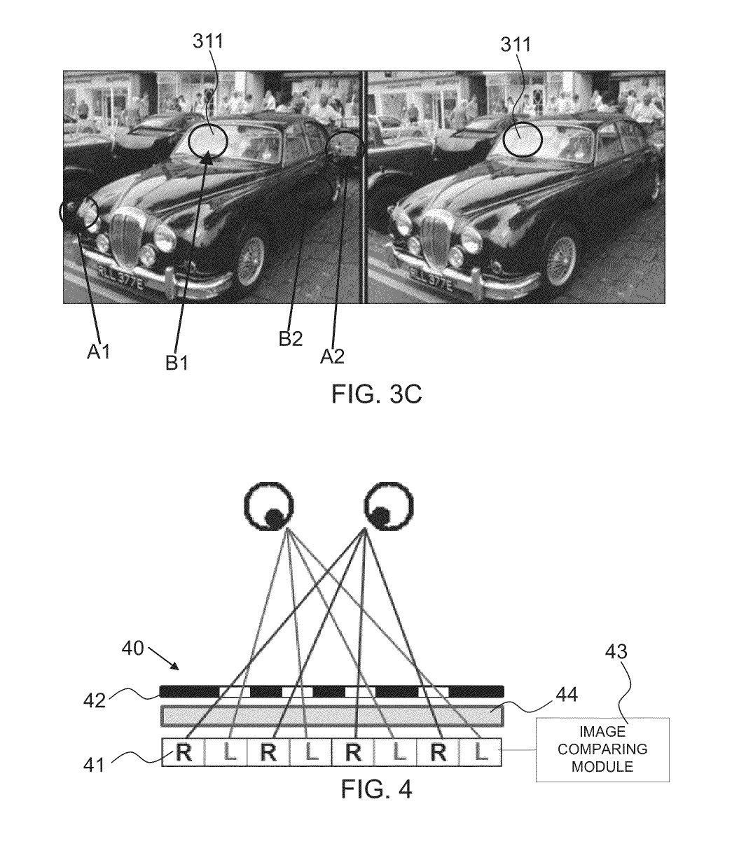

Please refer to FIG. 3A to FIG. 3C. FIG. 3A shows a structural diagram of an autostereoscopic 3D display device in accordance with a first preferred embodiment of the present invention. FIG. 3B shows a structural diagram of a scattering module in accordance with the first preferred embodiment of the present invention. FIG. 3C shows a left eye image and a right eye image displayed by the autostereoscopic 3D display device in accordance with the first preferred embodiment of the present invention.

The autostereoscopic 3D display device 30 in accordance with the present preferred embodiment comprises a display panel 31, an autostereoscopic 3D panel 32, an image comparing module 33, and a scattering module 34. The display panel 21 is utilized for displaying a plurality of left eye images L and a plurality of right eye images R. The autostereoscopic 3D panel 32 is utilized for adjusting emitting angles of emitting lights of the left eye images L and emitting angles of emitting light of the right eye images R. The image comparing module 33 is utilized for comparing one gray level of each of the left eye images L with one gray level of a corresponding one of the right eye images R and generating a comparison result. The scattering module 34 is utilized for scattering at least a part of the emitting lights of the left eye images L and the emitting lights of the right eye images R according to the comparison result.

In the present preferred embodiment, the display panel 31 is a two-view display panel. The autostereoscopic 3D panel 32 is a barrier type autostereoscopic 3D panel. The scattering module 34 is a polymer dispersed liquid crystal (PDLC) film. The scattering module 34 is disposed at a light emitting surface side of the autostereoscopic 3D panel 32.

Please refer to FIG. 3B. FIG. 3B shows the structural diagram of the scattering module 34 in accordance with the first preferred embodiment of the present invention. The PDLC film is a smart film which adjusts lights by adjusting and controlling voltages to control transmittance. Liquid crystal molecules 341 are dispersed in a transparent polymer matrix by the PDLC film. Polymers provide a stable network structure for liquid crystal droplets. The liquid crystal molecules 341 are formed into micrometer-sized or nanometer-sized droplets. When no voltage is applied to two terminals of the PDLC film, the liquid crystal molecules 341 are randomly arranged. After the incident lights are injected, a plurality of refractions and a plurality of reflections are generated at an interface between each of the liquid crystal molecules 341 and the polymer matrix. As a result, a white scattering state is displayed as shown in the left diagram of FIG. 3B. When a voltage is applied to the two terminals of the PDLC film, the liquid crystal molecules 341 are arranged along an electric field. After the incident lights are injected, the refractions and the reflections are not generated and the incident lights directly pass through the scattering module 34 as shown in the right diagram of FIG. 3B.

The PDLC film comprises a plurality of scattering processing units 342 and a plurality of voltage applying units 343. The scattering processing units 342 are utilized for scattering emitting lights at different positions of the display panel 31. The voltage applying units 343 are utilized for applying controlling voltages for corresponding one of the scattering processing units 342. Each of the left eye images L and the right eye images R comprises a plurality of image comparing areas 311. The image comparing areas 311, the scattering processing units 342, and the voltage applying units 343 are in one-to-one correspondence. That is, each of the scattering processing units 342 can scatter the emitting lights from corresponding one of the image comparing areas 311 via corresponding one of the voltage applying units 343.

When the autostereoscopic 3D display device 30 in accordance with the present preferred embodiment is utilized, the image comparing module 33 firstly compares a gray level of each of the image comparing areas 311 in each of the left eye images L with a gray level of a corresponding one of the image comparing areas 311 in a corresponding one of the right eye images R.

For example, when a difference between a gray level of an image comparing area 311 in a left eye image L and a gray level of a corresponding image comparing area 311 in a corresponding right eye image R is smaller than a preset value, there is little difference between the gray level of the image comparing area 311 in the left eye image L and the gray level of the corresponding image comparing area 311 in the corresponding right eye image R. Accordingly, when the emitting lights in the image comparing area 311 are scattered, serious crosstalk does not occur between the left eye image L and the corresponding right eye image R. In the meantime, the moire pattern phenomenon in the image comparing area 311 can be decreased. As a result, the scattering module 34 is set to scatter the emitting lights in the image comparing area 311 in the left eye image L and the corresponding right eye image R.

When a difference between the gray level of the image comparing area 311 in the left eye image L and the gray level of the corresponding image comparing area 311 in the corresponding right eye image R is larger than or equal to the preset value, there is larger difference between the gray level of the image comparing area 311 in the left eye image L and the gray level of the corresponding image comparing area 311 in the corresponding right eye image R. Accordingly, when the emitting lights in the image comparing area 311 are scattered, serious crosstalk occurs between the left eye image L and the corresponding right eye image R. As a result, the scattering module 34 is set to not scatter the emitting lights in the image comparing area 311 in the left eye image L and the corresponding right eye image R.

As shown in FIG. 3C, a difference between a gray level of A1 (i.e. the image comparing area 311) in the left eye image L and a gray level of the corresponding position in the right eye image R and a difference between a gray level of A2 (i.e. the image comparing area 311) in the left eye image L and a gray level of the corresponding position in the right eye image R are larger. It represents that A1 and A2 (i.e. the image comparing areas 311) in the left eye image L and the right eye images R are objects of different gray levels. As a result, the scattering module 34 is set to not scatter the emitting lights in A1 and A2 (i.e. the image comparing areas 311) in the left eye image L and the emitting lights in A1 and A2 (i.e. the image comparing areas 311) in the right eye image R.

A difference between a gray level of B1 (i.e. the image comparing area 311) in the left eye image L and a gray level in the corresponding position in the right eye image R and a difference between a gray level of B2 (i.e. the image comparing area 311) in the left eye image L and a gray level in the corresponding position in the right eye image R are smaller. It represents that B1 and B2 (i.e. the image comparing areas 311) in the left eye image L and the right eye image R are objects of same gray level. As a result, the scattering module 34 is set to scatter the emitting lights in B1 and B2 (i.e. the image comparing areas 311) in the left eye image L and the emitting lights in the right eye image R.

The emitting lights of the left eye images L and the emitting lights of the right eye images R emit from the display panel 31, and then the autostereoscopic 3D panel 32 adjusts emitting angles of the emitting lights of the left eye images L and emitting angles of the emitting lights of the right eye images R. That is, the emitting lights of the right eye images R in light paths of the emitting lights of the left eye images L are blocked, and the emitting lights of the left eye images L in light paths of the emitting lights of the right eye images R are blocked.

The scattering module 34 scatters at least a part of the emitting lights of the left eye images L and the emitting lights of the right eye images R according to comparison results of the image comparing module 33.

Specifically, when the scattering module 34 is set by the image comparing module 33 to scatter the emitting lights of one of the image comparing areas 311 of one of the left eye images L and the emitting lights of a corresponding one of the image comparing areas 311 of a corresponding one of the right eye images R, a corresponding one of the voltage applying units 343 of the scattering module 34 does not provide a controlling voltage for a corresponding one of the scattering processing units 342. Accordingly, the molecules 341 in the PDLC film corresponding to the one of the image comparing areas 311 are in a white scattering state. That is, the corresponding one of the scattering processing units 342 scatters the emitting lights in the one of the image comparing areas 311 of the display panel 31.

When the scattering module 34 is set by the image comparing module 33 to not scatter the emitting lights of one of the image comparing areas 311 of one of the left eye images L and the emitting lights of a corresponding one of the image comparing areas 311 of a corresponding one of the right eye images R, a corresponding one of the voltage applying units 343 of the scattering module 34 applies a controlling voltage to a corresponding one of the scattering processing units 342. Accordingly, the molecules 341 in the PDLC film corresponding to the one of the image comparing areas 311 are arranged in a regular direction. That is, the corresponding one of the scattering processing units 342 does not scatter the emitting lights in the corresponding one of the image comparing areas 311 of the display panel 31.

Thereafter, the scattering module 34 accomplishes to scatter at least a part of the emitting lights of the left eye images L and the emitting lights of the right eye images R (the emitting lights of the display panel 31).

Finally, the emitting lights via the scattering module 34 are received by a user's eyes, thereby the user can view one 3D display image with small crosstalk and decreased moire pattern phenomenon.

The autostereoscopic 3D display device in accordance with the present preferred embodiment scatters a part of emitting lights of one display image by disposing the image comparing module and the scattering module, thereby reducing the moire pattern phenomenon on the basis of without increasing the crosstalk of the display image.

Please refer to FIG. 4. FIG. 4 shows a structural diagram of an autostereoscopic 3D display device in accordance with a second preferred embodiment of the present invention. The autostereoscopic 3D display device 40 in accordance with the present preferred embodiment comprises a display panel 41, an autostereoscopic 3D panel 42, an image comparing module 43, and a scattering module 44. A difference between the present preferred embodiment and the first embodiment is that the scattering module 44 is disposed between the display panel 41 and the autostereoscopic 3D panel 42.

When the autostereoscopic 3D display device 40 in accordance with the present preferred embodiment is utilized, the image comparing module 43 firstly compares a gray level of each of image comparing areas in each of left eye images L with a gray level of a corresponding one of image comparing areas in a corresponding one of right eye images R.

The emitting lights of the left eye images L and the emitting lights of the right eye images R emit from the display panel 41.

Then, the scattering module 44 scatters at least a part of the emitting lights of the left eye images L and the emitting lights of the right eye images R according to comparison results of the image comparing module 43.

Finally, the emitting lights which are processed by the scattering module 44 pass the autostereoscopic 3D panel 42 and are received by a user's eyes, thereby the user can view one stereoscopic 3D display image with small crosstalk and decreased moire pattern phenomenon.

The autostereoscopic 3D display device in accordance with the present preferred embodiment scatters a part of the emitting lights of one display image by disposing the image comparing module and the scattering module, thereby reducing the moire pattern phenomenon on the basis of without increasing the crosstalk of the display image.

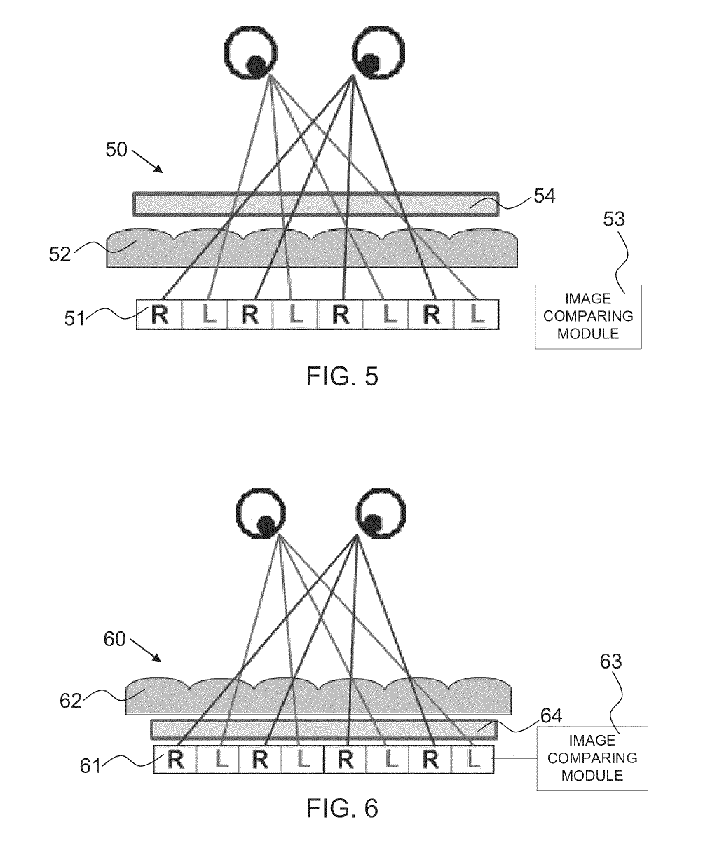

Please refer to FIG. 5. FIG. 5 shows a structural diagram of an autostereoscopic 3D display device in accordance with a third preferred embodiment of the present invention. The autostereoscopic 3D display device 50 in accordance with the present preferred embodiment comprises a display panel 51, an autostereoscopic 3D panel 52, an image comparing module 53, and a scattering module 54. A difference between the present preferred embodiment and the first preferred embodiment is that the autostereoscopic 3D panel 52 is a lens type autostereoscopic 3D panel.

A particular operational principle of the lens type autostereoscopic 3D panel is similar to that of the barrier type autostereoscopic 3D panel. The lens type autostereoscopic 3D panel and the barrier type autostereoscopic 3D panel can be operated such that one user's left eye (or right eye) receives the left eye images (or right eye images) and does not receive the right eye images (or left eye images). Accordingly, the particular operational principle of the autostereoscopic 3D display device 50 in accordance with the present preferred embodiment is the same as or similar to the descriptions in the first preferred embodiment and can be referred to the descriptions of the autostereoscopic 3D display device in the first preferred embodiment.

Please refer to FIG. 6. FIG. 6 shows a structural diagram of an autostereoscopic 3D display device in accordance with a fourth preferred embodiment of the present invention. The autostereoscopic 3D display device 60 in accordance with the present preferred embodiment comprises a display panel 61, an autostereoscopic 3D panel 62, an image comparing module 63, and a scattering module 64. A difference between the present preferred embodiment and the second embodiment is that the autostereoscopic 3D panel 62 is a lens type autostereoscopic 3D panel.

A particular operational principle of the lens type autostereoscopic 3D panel is similar to that of the barrier type autostereoscopic 3D panel. The lens type autostereoscopic 3D panel and the barrier type autostereoscopic 3D panel can be operated such that one user's left eye (or right eye) receives the left eye images (or right eye images) and does not receive the right eye images (or left eye images). Accordingly, the particular operational principle of the autostereoscopic 3D display device 60 in accordance with the present preferred embodiment is the same as or similar to the descriptions in the second preferred embodiment, and thus it can be referred to the descriptions of the autostereoscopic 3D display device in the second preferred embodiment.

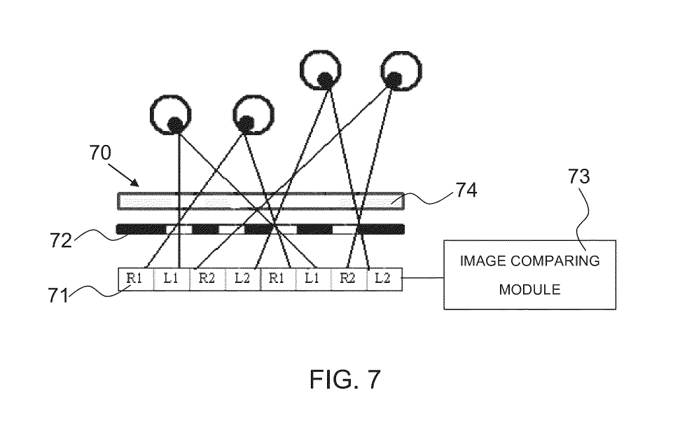

Please refer to FIG. 7. FIG. 7 shows a structural diagram of an autostereoscopic 3D display device in accordance with a fifth preferred embodiment of the present invention. The autostereoscopic 3D display device 70 in accordance with the present preferred embodiment comprises a display panel 71, an autostereoscopic 3D panel 72, an image comparing module 73, and a scattering module 74. A difference between the present preferred embodiment and the first embodiment is that the display panel 71 of the autostereoscopic 3D display device 70 is a multi-view display panel. In the present preferred embodiment, the display panel 71 is a four-view display panel.

The four-view display panel can display two left eye images and two right eye images at the same time, such that the user can view the corresponding left eye images and the corresponding right eye images at different angles. As a result, 3D effect of one image can be implemented better.

The four-view display panel is set to display first left eye images L1, second left eye images L2, first right eye images R1, and second right eye images R2. The first left eye images L1 and the first right eye images R1 form a 3D image from one view. The second left eye images L2 and the second right eye images R2 form a 3D image from another view. Each of the first left eye images L1, the first right eye images R1, the second left eye images L2, and the right eye images R2 comprises a plurality of image comparing areas. Each of the image comparing areas is corresponding to a scattering processing unit and a voltage applying unit of the scattering module 74.

The image comparing module 73 compares a gray level in each of the left eye images L1 (or second left eye images L2) with a gray level in a corresponding position of the right eye images R1 (or second right eye image R2) and generates comparison results.

The scattering module 74 scatters or does not scatter emitting lights of the left eye images (first left eye image L1 or second left eye image L2) and emitting lights of the right eye images (first right eye images R1 or second right eye images R2) according to the comparison results.

Certainly, a multi-view display panel may be utilized in the present invention, and an operational principle thereof is similar to that of the four-view display panel and is not described in detail herein.

Please refer to FIG. 3A, FIG. 3B, and FIG. 3C. Preferably, when the voltage applying unit 343 can adjust the controlling voltage applied to the scattering processing unit 342, the scattering unit 34 can determine the controlling voltage applied to the scattering processing unit 342 according to a comparison result of an image comparing area.

When a difference between a gray level of one of image comparing areas 311 in one of the left eye images L and a gray level of a corresponding one of the image comparing areas 311 in a corresponding one of the right eye images R is larger, the voltage applying unit 343 of the scattering module 34 applies a larger controlling voltage to a corresponding scattering processing unit 342, so that the scattering processing unit 342 slightly scatters the emitting lights of the one of the image comparing areas 311 or the scattering processing unit 342 does not scatter the emitting lights of the one of the image comparing areas 311.

When a difference between a gray level of one of the image comparing areas 311 in one of the left eye images L and a gray level of a corresponding one of the image comparing areas 311 in a corresponding one of the right eye images R is small, the voltage applying unit 343 of the scattering module 34 applies a smaller controlling voltage or does not apply a controlling voltage to a corresponding scattering processing unit 342, so that the scattering processing unit 342 significantly scatters the emitting lights of the one of the image comparing areas 311.

Since the voltage applying unit 343 can adjust the controlling voltage, the emitting lights can be flexibly controlled to be scattered. As a result, the moire pattern phenomenon and the image crosstalk of the autostereoscopic 3D display device can be improved.

The autostereoscopic 3D display device in accordance with the present invention scatters a part of the emitting lights of one display image by disposing the image comparing module and the scattering module, thereby reducing the moire pattern phenomenon on the basis of without increasing the crosstalk of the display image. Accordingly, the technical problems that the moire pattern phenomenon is serious or the crosstalk of the display image is large in a conventional autostereoscopic 3D display device in the prior art are solved.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structures.

What is claimed is:

1. An autostereoscopic 3D display device, comprising:
a display panel for displaying a plurality of left eye images and a plurality of right eye images;
an autostereoscopic 3D panel for adjusting emitting angles of emitting lights of the left eye images and emitting angles of emitting lights of the right eye images;
an image comparing module for comparing a gray level of each of the left eye images with a gray level of a corresponding one of the right eye images and generating comparison results; and
a scattering module for scattering at least a part of the emitting lights of the left eye images and the emitting lights of the right eye images according to the comparison results,
wherein the autostereoscopic 3D panel is a barrier type autostereoscopic 3D panel or a lens type autostereoscopic 3D panel, the scattering module is disposed between the display panel and the autostereoscopic 3D panel or disposed at a light emitting surface side of the autostereoscopic 3D panel.

2. The autostereoscopic 3D display device of claim 1, wherein each of the left eye images and the right eye images comprises a plurality of image comparing areas,
when a difference between a gray level of one of the image comparing areas in one of the left eye images and a gray level of a corresponding one of the image comparing areas in a corresponding one of the right eye images is smaller than a preset value, the scattering module scatters the emitting lights of the one of the image comparing areas in the one of the left eye images and the emitting lights of the corresponding one of the image comparing areas in the corresponding one of the right eye images;
when the difference between the gray level of the one of the image comparing areas in the one of the left eye images and the gray level of the corresponding one of the image comparing areas in the corresponding one of the right eye images is larger than the preset value, the scattering module does not scatter the emitting lights of the one of the image comparing areas in the one of the left eye images and the emitting lights of the corresponding one of the image comparing areas in the corresponding one of the right eye images.

3. The autostereoscopic 3D display device of claim 2, wherein the scattering module is a polymer dispersed liquid crystal film, and the polymer dispersed liquid crystal film comprises:
a plurality of scattering processing units for scattering emitting lights at different positions of the display panel; and
a plurality of voltage applying units for applying controlling voltages for the scattering processing units,
wherein the scattering processing units and the voltage applying units are in one-to-one correspondence.

4. The autostereoscopic 3D display device of claim 3, wherein when one of the voltage applying units applies one controlling voltage to a corresponding one of the scattering processing units, the emitting lights of the display panel pass the corresponding one of the scattering processing units;
when the one of the voltage applying units applies no controlling voltage to the corresponding one of the scattering processing units, the corresponding one of the scattering processing units scatters the emitting lights of the display panel.

5. The autostereoscopic 3D display device of claim 3, wherein the image comparing areas and the scattering processing units are in one-to-one correspondence.

6. The autostereoscopic 3D display device of claim 1, wherein each of the left eye images and the right eye images comprises a plurality of image comparing areas,
the scattering module is a polymer dispersed liquid crystal film, and the polymer dispersed liquid crystal film comprises:
a plurality of scattering processing units for scattering emitting lights at different positions of the display panel; and
a plurality of voltage applying units for applying controlling voltages for the scattering processing units,
wherein the scattering processing units and the voltage applying units are in one-to-one correspondence;
the scattering module determines the controlling voltages applied to the scattering processing units according to the comparison results.

7. The autostereoscopic 3D display device of claim 1, wherein the display panel is a two-view display panel or a multi-view display panel.

8. The autostereoscopic 3D display device of claim 1, wherein the display panel is a multi-view display panel, the multi-view display panel is utilized for displaying at least two left eye images and at least two right eye images at the same time, and the image comparing module is utilized for comparing one gray level of each of the left eye images with a gray level of a corresponding one of the right eye images and generating comparison results.

9. An autostereoscopic 3D display device, comprising:
a display panel for displaying a plurality of left eye images and a plurality of right eye images;
an autostereoscopic 3D panel for adjusting emitting angles of emitting lights of the left eye images and emitting angles of emitting lights of the right eye images;
an image comparing module for comparing a gray level of each of the left eye images with a gray level of a corresponding one of the right eye images and generating comparison results; and
a scattering module for scattering at least a part of the emitting lights of the left eye images and the emitting lights of the right eye images according to the comparison results.

10. The autostereoscopic 3D display device of claim 9, wherein each of the left eye images and the right eye images comprises a plurality of image comparing areas,
when a difference between a gray level of one of the image comparing areas in one of the left eye images and a gray level of a corresponding one of the image comparing areas in a corresponding one of the right eye images is smaller than a preset value, the scattering module scatters the emitting lights of the one of the image comparing areas in the one of the left eye images and the emitting lights of the corresponding one of the image comparing areas in the corresponding one of the right eye images;
when the difference between the gray level of the one of the image comparing areas in the one of the left eye images and the gray level of the corresponding one of the image comparing areas in the corresponding one of the right eye images is larger than the preset value, the scattering module does not scatter the emitting lights of the one of the image comparing areas in the one of the left eye images and the emitting lights of the corresponding one of the image comparing areas in the corresponding one of the right eye images.

11. The autostereoscopic 3D display device of claim 10, wherein the scattering module is a polymer dispersed liquid crystal film, and the polymer dispersed liquid crystal film comprises:
a plurality of scattering processing units for scattering emitting lights at different positions of the display panel; and
a plurality of voltage applying units for applying controlling voltages for the scattering processing units,
wherein the scattering processing units and the voltage applying units are in one-to-one correspondence.

12. The autostereoscopic 3D display device of claim 11, wherein when one of the voltage applying units applies one controlling voltage to a corresponding one of the scattering processing units, the emitting lights of the display panel pass the corresponding one of the scattering processing units;
when the one of the voltage applying units applies no controlling voltage to the corresponding one of the scattering processing units, the corresponding one of the scattering processing units scatters the emitting lights of the display panel.

13. The autostereoscopic 3D display device of claim 11, wherein the image comparing areas and the scattering processing units are in one-to-one correspondence.

14. The autostereoscopic 3D display device of claim 9, wherein the autostereoscopic 3D panel is a barrier type autostereoscopic 3D panel.

15. The autostereoscopic 3D display device of claim 9, wherein the autostereoscopic 3D panel is a lens type autostereoscopic 3D panel.

16. The autostereoscopic 3D display device of claim 9, wherein the scattering module is disposed between the display panel and the autostereoscopic 3D panel.

17. The autostereoscopic 3D display device of claim 9, wherein the autostereoscopic 3D panel is disposed at a light emitting surface side of the autostereoscopic 3D panel.

18. The autostereoscopic 3D display device of claim 9, wherein each of the left eye images and the right eye images comprises a plurality of image comparing areas,
the scattering module is a polymer dispersed liquid crystal film, and the polymer dispersed liquid crystal film comprises:
a plurality of scattering processing units for scattering emitting lights at different positions of the display panel; and
a plurality of voltage applying units for applying controlling voltages for the scattering processing units,
wherein the scattering processing units and the voltage applying units are in one-to-one correspondence;
the scattering module determines the controlling voltages applied to the scattering processing units according to the comparison results.

19. The autostereoscopic 3D display device of claim 9, wherein the display panel is a two-view display panel or a multi-view display panel.

20. The autostereoscopic 3D display device of claim 19, wherein the display panel is the multi-view display panel, the multi-view display panel is utilized for displaying at least two left eye images and at least two right eye images at the same time, and the image comparing module is utilized for comparing one gray level of each of the left eye images with a gray level of a corresponding one of the right eye images and generating comparison results.
